(19) United States
(12) Patent Application Publication
(10) Pub. No.: US 2008/0174553 A1
(43) Pub. Date: Jul. 24, 2008

(54) Computer Device

(75) Inventor: Anders Trell Trust, Buffalo, NY (US)

Correspondence Address: TORYS LLP, 79 WELLINGTON ST. WEST, SUITE 3000, TORONTO, ON, M5K 1N2, omitted

(73) Assignee: ANDERS TRELL TRUST, Buffalo, NY (US)

(21) Appl. No.: 10/538,862

(22) PCT Filed: Dec. 17, 2003
(86) PCT No.: PCT/US03/40015

§ 371 Date: Jan. 8, 2008

Related U.S. Application Data
(60) Provisional application No. 60/434,236, filed on Dec. 19, 2002.

(51) Int. Cl. G09G 5/08

(52) U.S. Cl. 345/163

(57) ABSTRACT

A computer input device for inputting graphical location data and alphanumerical data. The device is arranged with a keypad for the input of the alphanumerical data. According to the invention, keys of the keypad are not only used for input by means of individually enacted keys, but also for input by means of two or more simultaneously enacted adjacent or non-adjacent keys, thereby enhancing the gamut of input considerably. Furthermore, a user may also set the keypad in a number of modes, (e.g. Non-Shifted mode, Shift mode, Num mode and Num-Lock mode), thereby further enhancing the input capability considerably. Advantageously, certain keys may also be given a user programmable function.

### FIELD OF THE INVENTION

The present invention relates generally to a computer input device for inputting both graphical location data for graphical objects on a graphical display, and alphanumerical data.

### BACKGROUND OF THE INVENTION

Computer input devices, such as a conventional computer mouse, have been around for a number of years, designed and intended solely for the purpose of moving a cursor or other graphical object on a graphical display of a computer, in a simpler and quicker way than with on-board keyboard controls (e.g. the arrow keys on a QWERTY keyboard); and additionally, by means of click-buttons, scroll-wheels etc., to effectuate some cursor-pointed commands/actions. More recently, on-board touch-pads on lap top computers or designated touch sensitive areas of a computer screen (e.g. a Tablet PC) are also common. Mentioned conventional mouse devices and similar computer input devices are prior art, hence here not described other than for reference. However, it should be stressed that their present ability is restricted to that of detecting movement/position change (+clicks etc.) for enacting a cursor; and that they can do this in a number of ways, mentioned here mechanical (roller ball, finger tip), optical mouse, or gyroscopic motion sensor input device.

These prior art conventional mouses are conventionally separate from the computer keyboard (e.g. QWERTY keyboard), and hence have a very narrowly confined territory and require that computer users using two hands to type must take one hand off the keyboard in writing when handling the conventional mouse; and it also means that present cordless conventional mouses (e.g. by IR, RF, Bluetooth, and there are also similarly cordless separate keyboards available) are not of much help, apart from reducing cable mess at the desk—the overall set up remains the same and often quite cumbersome. Numerical key pads are also known, typically used by persons operating various types of programs requiring numerical data entry, but the problem remains, such as a user is likely to prefer using their best hand for numerical input and for operating a mouse, with consequential hand repositioning. This could be overcome by a mouse incorporating a numerical keypad as an additional feature, but this would still restrict added input to numerical data only and not alphanumerical data. Such a combination of a conventional mouse and a numerical keypad has been proposed in U.S. Pat. No. 5,457,480. The device in U.S. Pat. No. 5,457,480 includes a hinged hood covering the keypad when it is not in use, which is an awkward configuration for some users.

A conventional mouse is a fairly small object; usually a palm covers it comfortably for good grip and steer without taking up too much room. With only some click buttons, this leaves empty space on the surface of the mouse that is just meant for gripping and holding (or at the touch pad for tip movements). The empty space on the surface of the conventional mouse is too small for any manageable QWERTY keypad structure and so far, mouses have been unable to directly enter alphanumerical data (i.e. letters, digits, punctuation etc.) One known method for numerical input directly by a conventional mouse is to go into a screen display (i.e. on-screen calculator), and point and click the wanted figures, which is an indirect and tedious procedure.

It would be an accomplishment and advantage to have a mouse which in addition to just its traditional features also could be used to type with, enter alphanumerical text, up to or above the standard and acquired speed and ease of the use of a QWERTY keyboard. This would free a user from strict placing, set-up and hand change demands, and may well end up in overall better precision, speed, comfort and ergonomics. Also, it would considerably expand the present “mouse territory” into other than just personal computer areas, such as intelligent (IT) “third generation” interactive home appliances, “Internet”—TV:s etc., so that they might be better regarded as more universal remote controls, especially if cordless. The present invention is intended to disclose functional principles/methods and devices for giving an otherwise conventional mouse or similar computer input device an alphanumerical text entry capability.

### SUMMARY OF THE INVENTION

An object of the present invention is to free the computer user of the many physical constraints described above, and giving versatility and universality to the mouse or other computer input device, overall comfort and mobility; and to achieving this by simple, exact and easy-to-master means. It is then preferred that the base mouse be of the aforementioned cordless species albeit not an absolute stipulation.

An aspect of the present invention is a computer input device for inputting graphical location data and alphanumerical data to a computer having a graphical display, comprising a graphical location data entry portion, including at least one click button, operative for inputting graphical location data to a computer having a graphical display, and an alphanumerical data entry portion, including a plurality of keys, operative for inputting alphanumerical data to a computer, wherein the inputting of alphanumerical data includes an enactment of one or more keys.

Another aspect of the present invention is a method of receiving information in a computer from a computer input device of the present invention as described above; said method comprising steps of receiving information from said device representing an enactment of at least one key on said device; converting said information into alphanumerical data; and transmitting said alphanumerical data to a computer application (i.e. software, device driver or operating system) executing in said computer.

Another aspect of the present invention is a computer readable media storing software code executable on a computer connected to a computer input device of the present invention as described above, wherein said software code is operable to perform the method of receiving information in a computer from a computer input device as described above.

The present invention discloses a keypad arrangement attached on the aforementioned empty space of a mouse and integrated in same's functioning for extended input/output of alphanumerical data. For example, a conventional numerical row matrix 3 by 4 (12 keys) keypad can be used as a plain numerical keyboard (e.g. having a calculator order or telephone order numbering lay-out) in such a way, that when a key is duly enacted, it will send the information or code for the enacted key along the same communication link to the computer, as the mouse already has for it's routine information codes, and in addition to those, and which would be advantageous in plain numeric jobs. This can be done much due to the fact and realization that it is the received codes that govern the PC's response and entering, rather than the ways by which it receives the codes, so if a character's code arrives on same path as a cursor-directing one, it is still distinctly identified. As mentioned, the empty space available on a conventional computer mouse, such that it is not overly clumsy, is very restricted, such that if a keypad is to be placed there it would likely not exceed a 4×4, row matrix, in order also that the individual keys do not become too small or congested for correct enactment of keys. A standard 3×4, telephone-order, configuration is thus here preferred. Such a 3×4 telephone-order configurated keypad is fairly small, has enough (hitherto latent) capacity, and is a common standard that is well known and used by almost everyone in every-day practice.

With this arrangement alone it is possible to select and send codes for alphanumerical data such as digits, letters, punctuation and other symbols to the computer by employing protocols similar to that of the text messaging of mobile phones (e.g. SMS or Short Messaging Service), and by using the mouse to direct the cursor to the an on-screen character-map and then cut and copy wanted signs to text. However, such laborious and restricted formats are inferior (i.e. slower and more cumbersome) to using the regular QWERTY computer keyboard, and hence a mere 3×4 keypad mounted on a mouse would offer little advantage for complete alphanumerical data entry, unless such restrictions are removed. The present invention is able to do this, partly by employing/adapting the concept of a polyphonic/chordic annotation method, as disclosed in an international patent application, publication number WO/03007141, published on Jan. 23, 2003.

Unlike the prior art, the present invention makes it possible to use a mouse or other computer input device for input of substantially the same range of alphanumerical data (e.g. characters, numerals, symbols, punctuations, functions) as would be possible by use of a conventional (QWERTY) keyboard, thereby enhancing user input capability from a mouse considerably in relation to what has been possible in the prior art.

While the present invention will be described in detail with reference to certain embodiments, it is to be understood that the invention is not limited in its application to such detail as set forth in the description or drawings. The present invention is capable of being practiced in various ways and it is intended to cover all alternatives, modifications and equivalents which fall within the sphere and scope of the invention as defined by the appended claims.

### BRIEF DESCRIPTION OF THE DRAWINGS

The features of the present invention believed to be novel are set forth with particularity in the appended claims. The invention itself, both as to its organization and methodology, together with further objects and advantages thereof, may best be understood by reference to the following description taken in conjunction with the accompanying drawings in which:

FIG. 1 shows a top view of an integrated mouse and alphanumeric keypad device embodying features of the present invention for inputting graphical location data and alphanumerical data into a computer. This embodiment shows a mouse with two click buttons and a keypad mounted thereon with a 3×4 matrix of hard keys;

FIG. 2 shows a top view of an integrated touch pad and alphanumeric keypad device embodying features of the present invention for inputting graphical location data and alphanumeric data into a computer. This embodiment shows a touch pad with two click buttons that can be either hard keys or soft keys, and a keypad layout with a 3×4 matrix of soft keys;

FIG. 3 shows a 3×4 matrix of keys in a Write mode;

FIG. 4 shows a 3×4 matrix of keys in a Shift mode;

FIG. 5 shows a 3×4 matrix of keys in a Num mode;

FIG. 6 shows a 3×4 matrix of keys in a Shift-Num mode;

FIG. 7 shows a 3×3 matrix of keys in a Write mode; and

FIG. 8 shows a 2×6 matrix of keys in a Write mode.

### DEFINITIONS

The following terms are intended to have the following general meanings as they are used herein:

“mouse”—a computer input device used to manipulate the movement and actions of an on-screen cursor (i.e. pointing, selecting, moving and changing items on a computer screen) and enter characters and command functions, by the input of data to the computer. It includes, without limitation, other computer input devices having equivalent or similar function, such as a touchpad, trackball, joystick or an input device on a mobile telephone.

“gyroscopic”—demonstrating the principle of conservation of angular momentum in physics, as used in a gyroscopic motion sensor that uses light or infrared to detect changes in its position, such that no moving parts are required for the input device (i.e. optical mouse)

“computer”—a device that can be programmed to manipulate symbols. It can perform complex and repetitive procedures quickly, precisely and reliably, and can quickly store, process and retrieve large amounts of data. It includes without limitation, personal computers (PCs), lap-tops, mobile phones, IT interactive home appliances, and Internet-TV's.

“cursor”—an indicator consisting of an icon (moveable spot of light) on a visual display. Moving the cursor allows the user to point to commands or screen positions

“click button”—a button on a computer input device, or an enactment of a key or a combination of keys on the computer input device, operative for selecting graphical objects or initiating an action such as runing a program or opening or closing a file on the computer.

“key”—may be a hard key or soft key

“hard keys”—solid, physical keys of a keypad, including the keys of a membrane keypad, enacted by depressing the hard key

“soft keys”—abstract, virtual keys of a keypad (i.e. touchpad), including touch sensitive display fields, enacted by touching the soft key

“enact”—depress (i.e. for hard or soft keys), or touch (i.e. for soft keys)

“membrane keypad”—a layer of material covering the surface of the keypad to provide the user with tactile sensation such that the user is able to identify the location of each key by touch.

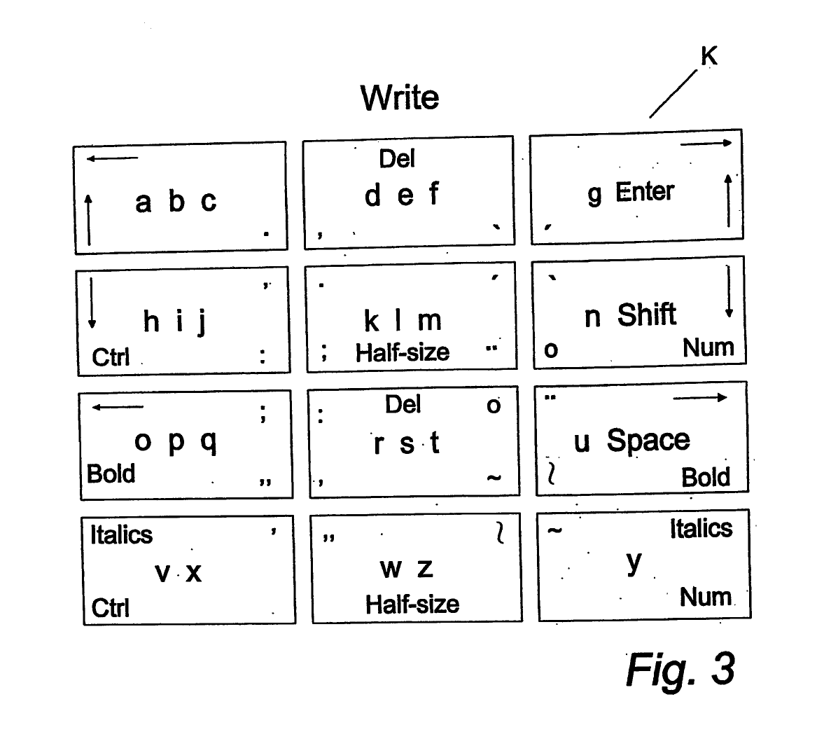

“Write mode”—a particular functioning arrangement of the computer input device whereby the data that is inputted is restricted to the data disclosed in FIG. 3.

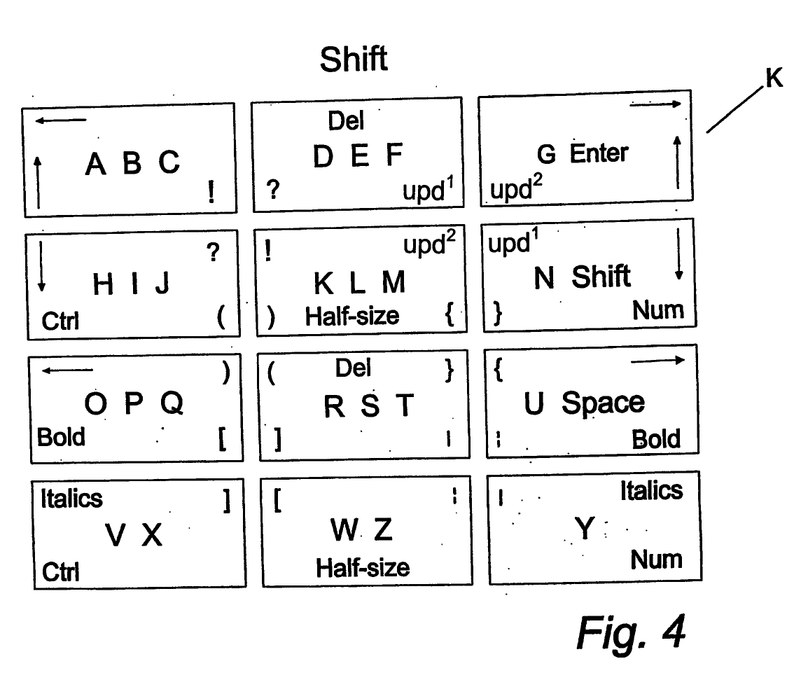

“Shift mode” or “Shifted mode”—a particular functioning arrangement of the computer input device whereby the data that is inputted is restricted to the data disclosed in FIG. 4.

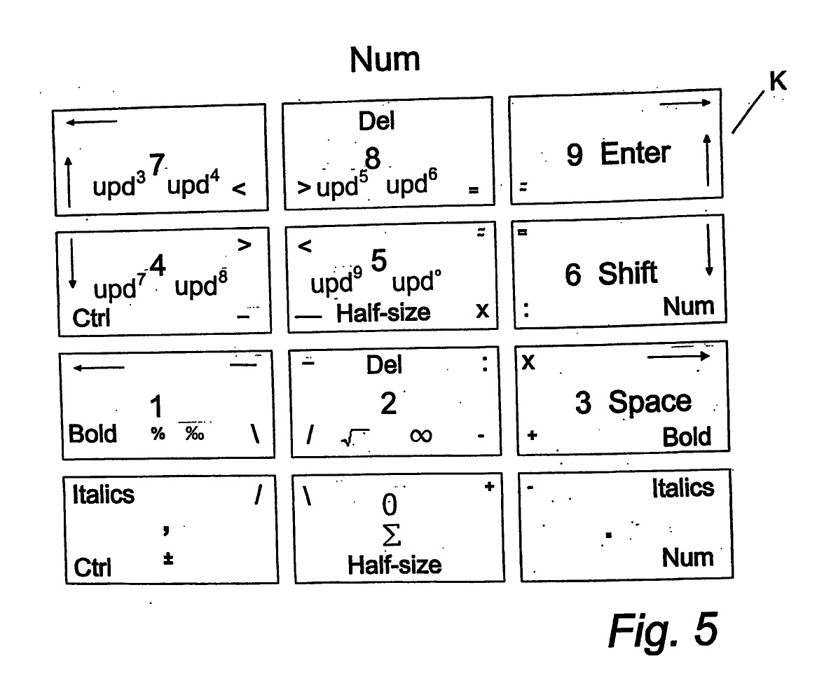

“Num mode”—a particular functioning arrangement of the computer input device whereby the data that is inputted is restricted to the data disclosed in FIG. 5.

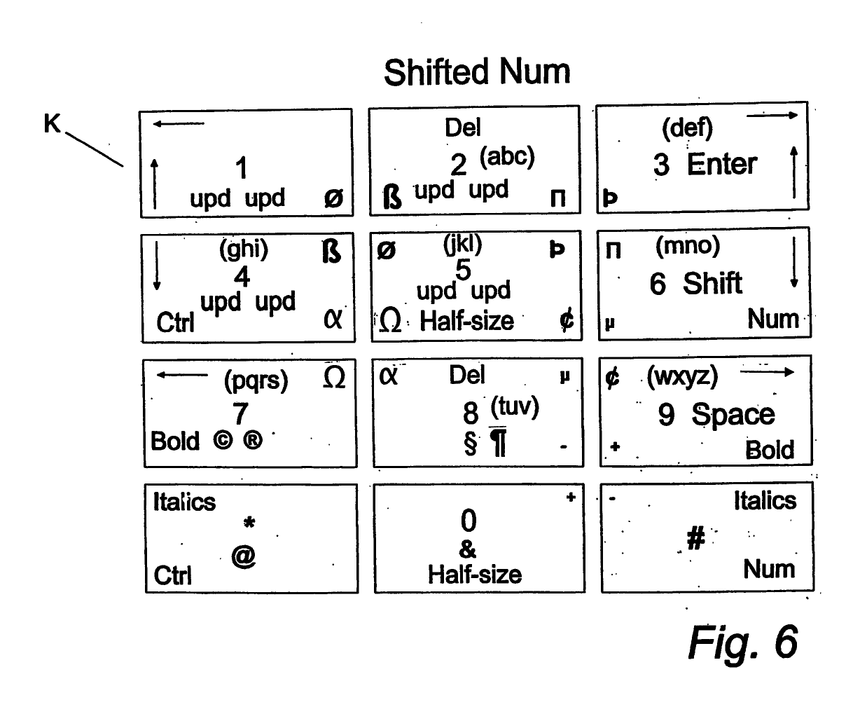

“Shifted Num mode”—a particular functioning arrangement of the computer input device whereby the data that is inputted is restricted to the data disclosed in FIG. 6.

“N key rollover mode”—a particular functioning arrangement of the computer input device whereby the simultaneous enactment of two or more keys results in the input of a command function or other data different from that of the keys enacted.

“Two key lockout mode”—a particular functioning arrangement of the computer input device whereby the simultaneous enactment of two or more keys results in the input of data from only one of the two keys enacted.

“graphical location data”—data that manipulates the movement and actions of an on-screen cursor (i.e. pointing, selecting, moving and changing items on a computer screen)

“alphanumerical data”—data pertaining to a character set containing one or more letters, digits, punctuation marks, symbols and command functions.

“character”—letter, digit, punctuation mark, accent or symbol.

“command function”—data (i.e. a character string) that tells a program to perform a specific action.

“upd”, “update” or “user programmable function”—command functions which may implement a program to input a phrase, word, symbol, command or other alphanumerical data.

“user programmable key”—a key or combination of keys that inputs a upd when enacted

“chord”—the enactment of two or more keys, either at the same time or in rapid succession without disengaging the earlier enacted key(s), (i.e. without lifting the finger(s) off of the earlier enacted key(s) until the final key is enacted).

“broken chord”—the enactment of two or more keys in rapid succession without disengaging the earlier enacted key(s), (i.e. without lifting the finger(s) off of the earlier enacted key(s) until the final key is enacted).

“block chord”—the enactment of two or more keys at the same time.

“simultaneous enactment”—enactment of a plurality of keys at the same time, or in rapid succession of each other without disengaging the earlier enacted key(s) (i.e. without lifting the finger(s) off of the earlier enacted key(s) until the final key is enacted).

“calculater order”—the ordering of keys on a keypad that is modelled after the ordering of keys on a keypad from a conventional calculator

“telephone order”—the ordering of keys on a keypad that is modelled after the ordering of keys on a conventional telephone dialpad.

“character map”—a display of alphanumerical data (i.e. characters) on a computer screen from which a cursor is used to select said data for input

### DESCRIPTION OF PREFERRED EMBODIMENTS

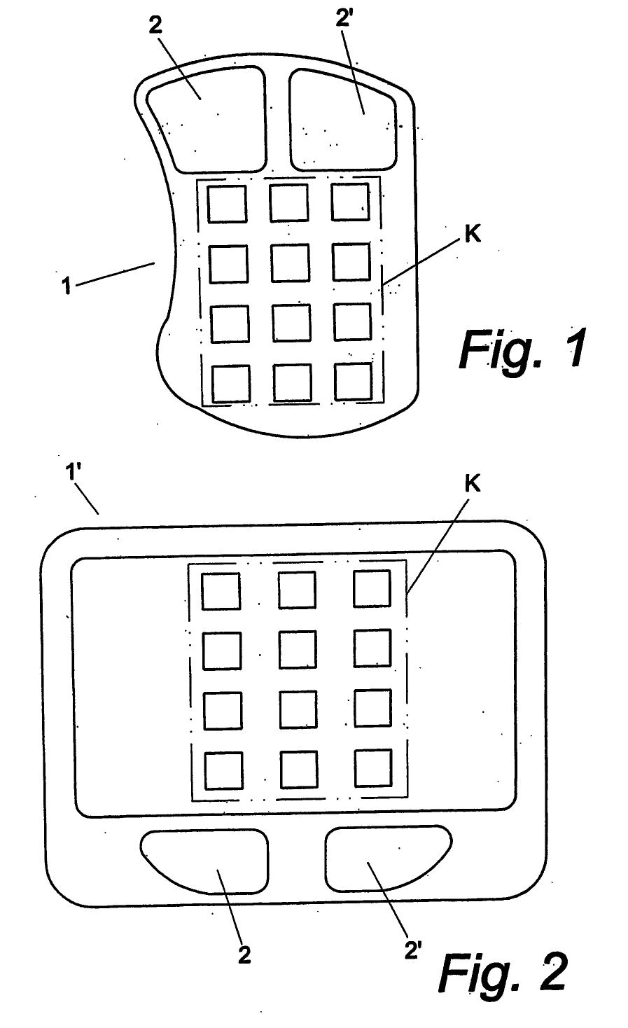

As shown in FIG. 1, a standard 3×4 row matrix keypad K arrangement rests on the mouse 1, which furthermore has two click buttons 2 and 2′. However, the device of the present invention may also have only one click button or more than two click buttons. In order to illustrate an example of how a keypad K can be arranged in connection with a touch pad 1′, such an arrangement is shown in FIG. 2. Since each individual key(s) can designate different letters, numerals, functions or symbols (signs) depending on activated mode, all keys are shown blank in FIGS. 1 and 2.

As disclosed in FIG. 3, the keypad in Write mode, allows input of only letters, punctuations and symbols. Further, the keys are arranged in telephone order. In addition, by putting the computer input device in the N key rollover mode, instead of the presently predominant Two key lockout mode, it is possible to devise a concept of decoding two or more keys simultaneously (i.e. block chord), or in rapid succession without disengaging the earlier enacted key(s), (i.e. broken chord) by depressing or touching, and to allotting specific signs or commands for such enactments. A most advantageous and comprehensive way of here doing this, which also does not disfavor left-handed users, is thought to be as below described.

FIG. 3 shows the keypad K in a basic Write mode for lower case letters. Referring to FIG. 3, the first letter “a” of the first key is inputted by enacting the key alone (i.e. key “1”); the second letter “b” of the first key is inputted by enacting the key together with the adjacent key directly below it (i.e. keys “1” and “4”); and the third letter “c” of the first key is inputted by enacting the key together with the adjacent key directly to the right of it (i.e. keys “1” and “2”). Referring to the keys on the bottom of the keypad in FIG. 3, the first letter “v” of the key is inputted by enacting the key alone (i.e. key “*”); and the second letter “x” of the key is inputted by enacting the key together with the adjacent key directly to the right of it (i.e. keys “*” and “0”). Referring to the keys on the right of the keypad in FIG. 3, the letter “g” of the key is inputted by enacting the key alone (i.e. key “3”); and the command function “ENTER” is inputted by enacting the key together with the adjacent key directly below it (i.e. keys “3” and “6”). Other command functions, punctuation data and other symbols are inputted by simultaneously enacting two or more keys that are diagonally adjacent to each other or separated by another key (i.e. non-adjacent to each other), as shown and marked on the keys in the respective figures. In summary, the data disclosed in FIG. 3 is inputted in the Write mode as follows: “a”=key “1”; “b”=keys “1” & “4”; “c”=keys “1” & “2”; “d”=key “2”; “e”=keys “2” & “5”; “ft=keys “2” & “3”; “g”=key “3”; “h”=key “4”; “i”=keys “4” & “7”; “j”=keys “4” & “5”; “k”=key “5”; “1”=keys “5” & “8”; “m”=keys “5” & “6”; “n”=key “6”; “o”=key “7”; “p”=keys “7” & “*”; “q”=keys “7” & “8”; “r”=“key “8”; “s”=keys “8” & “0”; “t”=keys “8” & “9”; “u”=key “9”’“v”=key “*”; “x”=keys “*” & “0”; “w”=key “0”; “z”=keys “0” & “#”; “y”=key “#”; “ENTER” command function=keys “3” & “6”; “SHIFT” command function=keys “6” & “9”; “SPACE” command function=keys “9” & “#”; “←”=keys “1” & “7”; “↑”=keys “1” & “3”; “→”=keys “3” & “9”; “↓”=keys “4” & “6”; “CTRL” command function=keys “4” & “*”; “BOLD” command function=keys “7” & “9”; “ITALICS” command function=keys “*” & “#”; “Half-Size” command function=keys “5” & “0”; “DEL” command function=keys “2” & “8”; “NUM” mode command function=keys “6” & “#”; “.”=keys “1” & “5”; “,”=keys “2” & “4”; “:”=keys “4” & “8”; “;”=keys “5” & “7”; “‘”=keys “7” & “0”; “′”=keys “8” & “*”; “’”=keys “2” & “6”=keys “3” & “5”; “\ddot{}”=keys “5” & “9”; “°”=keys “6” & “8”; “˜”=keys “8” & “#”; and “ζ”=keys “9” & “0”. As shown, the present invention allows input of command functions, the entire english alphabet, punctuation data and other symbols by way of a single mouse or computer input device, without having to direct the cursor to a separate on-screen character map that breaks the writing flow. In addition, one may use the present invention to input accents to form letters foreign to the english alphabet such as “ñ”, “ç”, “ö”, “\dot{a}”, “ô”), “é”, or “à”” Such non-english letters are formed by first enacting the keys to input the accent, and then following with an enactment to input the base letter. For example, while still in the Write mode, the following non-english character can be inputted as follows: “ñ”=keys “8” & “#”, followed by the enactment of keys to input the base letter “n” (key “6”). If only the accent “˜” is desired to be entered alone: “˜”=keys “8” & “#”, followed by “SPACE” command function (keys “9” & “#”). The input of accents to form non-english characters by using a single mouse or computer input device without needing to use a character map is advantageous in that it is much faster, more convenient and less cumbersome than the conventional method of using a QWERTY keyboard, conventional mouse and character map to input the same accent. Other like combinations can also be used for getting certain other specified results, and the protocols for effectuating such can quite vary, hence here not further specified. Apart from adjacent key combinations, wider interval or non-adjacent key combinations are also employed and then for editing commands such as indicated by the marks therefor. These combinations are here kept strict substantially straight horizontal or vertical with just one intermediate key so as to give ease in enactment of the keys with two fingers. Even simpler to enact are the often used “Enter”, “Shift” and “Space” command functions, as they are just the next key down. Similar to the QWERTY keyboard, the “Shift” command function gives capitals as well as changing the other writing characters. The editing commands persist stable though, through all modes. When in Shift mode, non-english capital letters can also be formed in similar fashion as, and by combination with, the accents provided (and at onset first “ordered”) in the Write mode. The same pattern of enacting keys or chords as described above in FIG. 3 is used for the input of the other alphanumerical data from the other modes referenced in FIG. 4, FIG. 5 and FIG. 6.

If the keypad K contains hard keys, inputting varying signs/marks and other data thereon through the different chords and modes might appear to be difficult to learn without a further step such as having each key provided with a display such as a LCD (Liquid Crystal Display). However, since the format of the keypad (e.g. 3×4 matrix) is so familiar to most users and furthermore, with the small tactile quill often provided on the middle “5” key to give good orientation, which also helps the vision impaired, and also with the possible immediate, error-alerting/correctness-confirming voice synthesis of inputted signs/commands, it is possible to quickly learn and become familar with inputting data on the keypad of the present invention without looking at the keys, just as an experienced QWERTY typist now can. Under a learning period and for practical reference, changeable, touch-through membranes covering the keypad and inscribed with, or displaying, the different modes signs can be designed and provided, as well as, of course, printed reference side diagrams and/or simultaneous display on the computer screen. The stable editing and command signs can be permanently imprinted or marked on the keypad or device adjacent to the keys. If the keypad has soft keys, different signs in different modes can be displayed thereon in real-time, but non-visual orientation thereon might not be so exact as with hard keys. However, the designated area of the keypad having soft keys could have the grid and quill installed there as tactile detectable rips/ridges or the like. Also, the maintained (except for the non-frequent x and z) alphabetical order, may assist. It is also here worth mentioning that the 3×4 keypad, with working as herein disclosed, can be virtualized on some suitable block (e.g. 123, QWE,ASD,ZXC) on a QWERTY keyboard itself (after some suitable activation/programming; cf. “Num” keys assignment on some present laptops).

FIG. 4 shows the keypad K in a Shift mode (or Caps Lock mode which can be effectuated by enacting the Shift mode twice in rapid succession; and can be released by one more enactment of the Shift mode), and is described with reference to the touch pad 1′ disclosed in FIG. 2 (or a designated area of a computer screen). This touch pad 1′ has a soft keypad grid displayed there on the area for tip movements, although separate areas could be provided as well, which however here is thought uneconomical and hence not preferred, and having two click buttons 2, 2′. As in the earlier FIG. 3, FIG. 4 shows the alphanumeric data, punctuation, symbols and command functions are displayed on the keys. In addition, upd (update functions) or user programmable functions are shown by the enactment of keys “2” & “6”, and also “3” & “5”, and are provided for user/producer ad lib programming. A touch pad is touch sensitive, and so only differentiation between tip movements and key punches has to be ensured. This can be done by, for example using different click strategies, and is here not elaborated on. The devices shown in FIGS. 1 and 2 are shown with two click buttons 2, 2′ customarily placed in the front first portion of a mouse, but one can certainly have only one click button or add more click buttons, scroll wheels, track balls etc., and locate such additional buttons or scroll wheels or track balls on the sides of the mouse, or include them in the keypad K capacity and assign specific key combinations therefor. Keys “1” and “*” can provide the same input as the left click button of a mouse; enactment of keys “3” and “#” can provide the same input as the right click button of the mouse; and the enactment of keys “2” and “0” can provide the same input as the middle click button of a mouse or a scroll wheel with a scroll function by, for example, taking the broken chord using keys “2” and “0” broken in a downward direction (i.e. enacting key “2” first and then key “0” in rapid succession) to input a downward scroll, and also by taking the broken chord using keys “0” and “2” in an upward direction (i.e. enacting key “0” first and then key “2” in rapid succession) to input an upward scroll; which can be inputted through all the modes.

FIGS. 5 and 6 also show keypad layouts, without a keypad supporting device or housing, and with suggested signs (put as per the principles of FIGS. 1 and 2; thus digits=single [one] key's enactment; most other signs indicated=double [two] keys' simultaneous enactment) for two complementing modes, Num mode and Shifted Num mode respectively, and effectuated by the keys marked Num; and the keys marked Shift plus the keys marked Num; respectively, and locked/released as described above regarding the Shift mode.

The Num mode gives here digits as per the calculator order (although the telephone order may coexist as an electable option for users preferring that or from cellphones' calculator programs used thereto, even in calculating etc.), and the maths signs as well as upd's can also, in addition to just typing, have arithmetic functioning, if thus programmed for in the computer (and activated for example by the Ctrl command function). In certain computers, numerical keypads (on board or detached), an upper-case mode for specific functions can be enabled by, for example, the Ctrl command function, and when in Num mode, similar can be offered (as a user electable option) with the present invention.

The Shifted Num mode gives here digits as per the telephone order and can also, if programmed in the computer, for example, by the upd's and activated by Ctrl, have telephone functioning (which may include mobile, SMS etc., hence the alternative, otherwise here somewhat redundant telephone standard alphabetization hinted). The keys through all the modes marked Ctrl and Half-size can have additional editing/menu functions, and the likewise Del, Italics, Bold as well as the arrows signs, being standard, should require no further explanation, other than that the latter also, for example, by some click-activation, could be employed as a joystick/scroll-wheel etc. equivalent to the mouse that moves the cursor, or that a separate such arrangement, e.g. a joystick; a track-ball; a gyroscopic motion sensor input device, is provided as well as a keypad K on-board the mouse; which all, although not generally preferred, meant within the inventive thought and claims herewith.

One can also here state that in languages like, for example Swedish, where some non-english letters, such as “a”, are very frequent used, and where the input of such may be cumbersome and slow, a possibility for shortcuts using the redundancy of the preferred layouts exists. Thus, without limitation, the simultaneous enactment of keys “1” and “6” may (in Write/Shift mode and if user opts) input “ae′ or “AE”; the enactment of keys “1” and “9” may input “@”; the enactment of keys “1” and “#” may input “\dot{a}” or “\dot{A}”; the enactment of keys “1” and “0” may input “ä” or “Ä”; and the enactment of keys “7” and “3” may input “ö” or “Ö”. In addition, the enactment or depression of a key for a continuous amount of time can give straight digits in running text. In Num mode, when entering various math expressions (e.g. 2a by 6b, cos 4, 2x-5ybz etc., it could also be beneficial to offer an electable possibility to have straight (small) letters without mode change, e.g. by holding the corresponding (Write mode) key(s) down long. “Bouncing”, (i.e. rapid repetition for keys held down long), should then preferably be reserved just for function keys.

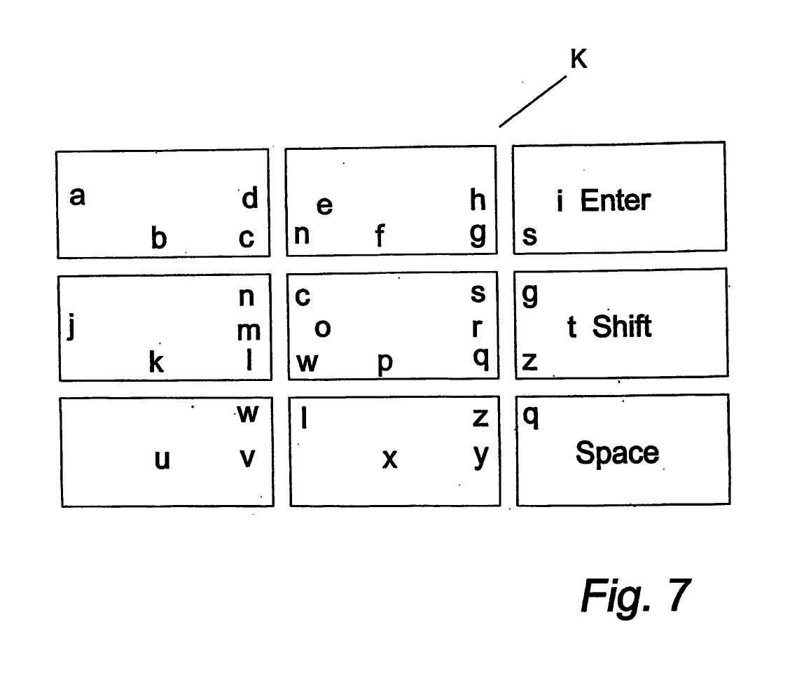

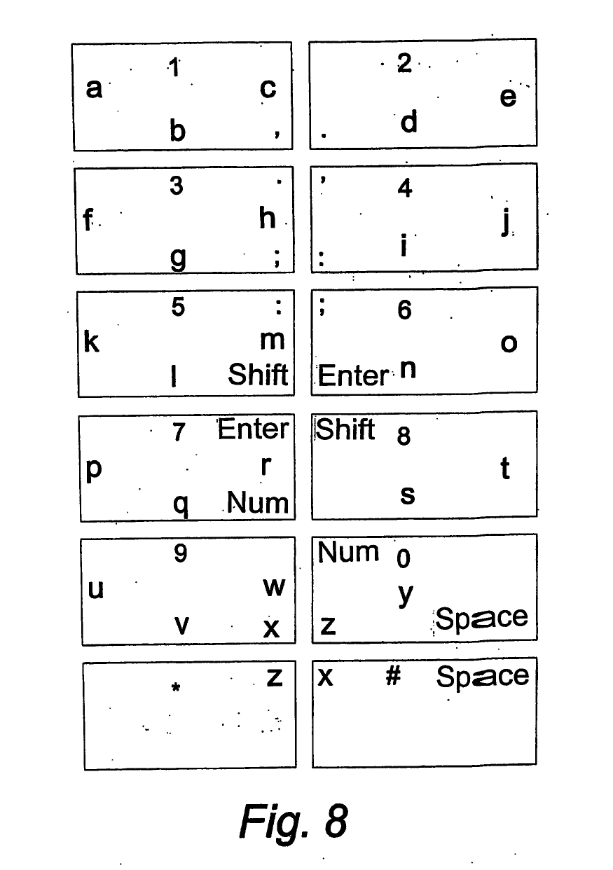

FIG. 7 is intended to show another possible alternative, where the standard 3×3 row matrix is used (but this could also be a 4×4, 5×4 or other matrix within the available limited space, which might be useful in letter-rich non-English languages, and/or for utilizing the keys of the “extra” row[s] in for example some single key commands like Enter, Backspace, Space, Shift, Ctrl, “→”, “Θ” etc., but which, if brought too far, is thought to mostly lead to confusion and thus not generally preferred) layout and how it might be lettered. A further possible example of key configuration is shown in FIG. 8, in which a 2×6 row matrix is shown. The examples shown in FIG. 7 and FIG. 8 are believed to disclose that the row matrix configuration can be considerably varied and not limited to only a 3×4 matrix, while maintaining the advantages obtained by means of the present invention. Many other non-conventional keypads and input devices (e.g. non-rectangular arrangements), specific key modifications or placements, in order to facilitate diagonal enactment of multiple keys by using just one finger, are also contemplated, where the physical mouse metaphor may no longer be so evident but the PC-function remains, (e.g. play stations equipped with the appropriate key arrangements), which are contemplated and thought within the present inventive thought and claims. However, for understandable reasons, a single row keypad matrix would not be suitable, and the invention is thus applicable on any row matrix having at least two rows.

A mobile phone or palmtop using Bluetooth, RF (radio frequency), IR (infrared), cell etc., can also accordingly be used with the present invention (remotely, as a mouse, to a PC and/or into itself in own text entry), if introduced to it's menu some cursor managing feature, for example by it's joystick or gyroscopic motion sensor input device; and for clicks some function buttons; and also enabling it's telephone/numerical keypad for enhanced functioning as herein disclosed. If of palmtop/communicator etc. size, a given possibility also exists for the keypad to be a more fullfledged QWERTY, although such an embodiment is here thought to be less advantageous.

One problem with a cordless mouse and a cordless keyboard today is the power source, which is typically batteries that must be changed or charged periodically, and which may be empty just when needed. However, also today, one may easily obtain a small hand-held calculator with a row matrix keypad (numerical 3×4 grid and some additional row[s] with function keys); LCD-display; embedded processor with keypad controller and good (often redundant) capacity; inbuilt rechargeable battery; and solar-cell for satisfying powering/charging even by normal indoor light sources, making it perpetually functional. Equipping such a calculator with for example Bluetooth RF which is very energy cheap (or for that matter, equipping a cordless mouse according to the present invention with above solar-cell/battery set-up), and adapting/enabling it for also be set to functioning according to the present invention (it's numeric row matrix for typing etc. and some function buttons or other means for cursor influencing etc.) should not be too much of a problem, and render yet another embodiment of the present invention possible. Also common remote controls could likewise be adopted/enabled to functioning according to the present invention; and above versions are also meant included in the inventive thought and claims herewith. Powering can naturally be solved also in other ways (e.g. fed from the receiver by the IR/RF or plain batteries), but the above is thought to be most advantageous.

An interesting possibility, which can work also with traditional QWERTY computer keyboards and mouses, although maybe not there so advantageous since one hand then must leave the keyboard in writing when to handle the mouse is, that one can use the drag function of the mouse in writing to speed up correct entry. The PC program can have a dictionary (also with one's own entered expressions etc.) and when having typed a few first letters of a typically rather long and maybe difficult to spell word, one can, for example, right click to select the typing cursor and then with the mouse drag through a then presented list, preferably a vertical window with the cursor initially on the first presented word, of the entire dictionary vocabulary of words, alphabetically ordered, that start with entered letters. When the wanted word is hit, left click can put the word in full; in proper place; in correct spelling; and without having to change grip or hand. Some chosen word can, so indicated, be presented in a basic form/tense and by, for example, right click, it can be revealed in all it's forms and the one word looked for can then be selected. For instance, a right click on typed “am” could present a list with the typed word on top (with a flag) and so another right click could yield: “am”, “be”, “are”, “been”, “being”, “is”, “was”, “were”, “we're”, “weren't”, etc., plus possibly at yet a right click, a selection of idiomatic expressions with chosen alternative. Possibly, however, the wanted word and spelling could actually be “ameliorate”, but which then could be found beneath, coming even closer if “ame” be typed. In comparison with dictionary based, word guessing formats like T9 etc. (even though same can be alternatively or coexisting employed) which don't collaborate with mouse functions and, once invoked, constantly come at every typed letter(s) suggesting just one alternative, whether one then calls for it or not and thus requiring constant refocusing and checking that the eventually entered word really was the wanted one, it is thought that better control, speed and precision is herewith achieved. And, analogously, (lists of) synonyms to written words; commonly used phrases; mathematical and chemical/physical tables/formulas (in Num mode); telephone/address lists (in Shifted Num mode); etc., can be dragged out and found item entered and/or performed.

Further, in regards to other possible alternatives, (i.e. deviations from the preferred embodiments), it is possible to keep the communication pathways of the graphical location data entry portion and the alphanumerical data entry portion (i.e. from the keypad) aggregate separated, just as now is the custom in the prior art. The input of graphical location data may have it's own separate communication pathway, and the input of alphanumerical data from a keypad may have it's own separate communication pathway. This can initially be simpler from a software/interfacing point of view (especially when prototyping), but in the long run it increases the hardware-burden and thus cost on the mouse and is therefore not here preferred, but nevertheless, as many other, mentioned or not, possible deviations from the preferred embodiments, meant included in the inventive thought and claims herewith.

As mentioned before, the present invention makes it possible to facilitate input of a range of alphanumerical data (such as characters, numerals, symbols, functions etc.), corresponding to a conventional QWERTY keyboard, and this large range is based on simultaneous input via preferably up to two keys. However, since a user may happen (or intend) to depress three adjacent keys (forming a triangular configuration, and especially so perhaps when practicing a one hand thumb input) at the same time, out of which only two keys really were intended, the controlling software associated with the device can be arranged to select two out of these three keys based on key relationship, (i.e. disregard the third key which has no function in connection with anyone of the other two keys depressed), such as the diagonal vs the straight substantially horizontal or vertical. Alternatively, the software can also be intentionally set to select the diagonal, which can make punctuation/accent etc. take, especially with just one finger, more easy, precise and quick.

In addition, a user, in certain situations, may wish to disable the input of alphanumerical data from the keypad K integrated with the mouse (while enabling the graphical location data entry portion of the mouse). Such a function is preferably incorporated, and this can be accomplished by means of a command function, (e.g. enactment of “Ctrl” and another specific key). Another command can activate input of alphanumerical data from the keypad K (while disabling the graphical location data entry portion of the input device). Such a method for enabling/disabling the keypad/mouse respectively is preferable as compared to using keys located below the surface of the mouse (which makes input difficult), as well as compared to the use of a hinged hood covering the keypad, as disclosed in U.S. Pat. No. 5,457,480, which is an expensive and fragile part, and which can easily be damaged, particularly at the hinged connection to the housing.

As disclosed in FIG. 3 through FIG. 8, two adjacent keys (or a single key) denominates a certain character, symbol, punctuation, numeral or command function, whereas some suggested less frequent command keys (i.e. Del, Ctrl, Italics, Num, Bold, Half-Size and the arrow keys) are separated by means of one key. This is a preferred configuration in order to minimize the risk for non-intended use of these keys.

### SCOPE OF THE INVENTION

The present invention has been described in an illustrative manner. It is to be understood that the terminology which has been used is intended to be in the nature of words of description rather than of limitation. Although various examples of combined elements of the invention have been described, it will also be understood that these are not intended to be exhaustive and features of one embodiment may be combined with those of another, and such other combinations are contemplated to be within the scope of the invention disclosed herein. Many modifications and variations of the present invention are possible in light of the above description that are readily apparent to one of skill in the art, and all such variations are intended to be encompassed by the present invention. Therefore, within the scope of the appended claims, the present invention may be practiced otherwise than as specifically described.

1. A device for inputting graphical location data and alphanumerical data to a computer having a graphical display, comprising:
(a) a graphical location data entry portion, including at least one click button, operative for inputting graphical location data to a computer having a graphical display; and
(b) an alphanumerical data entry portion, including a plurality of keys, operative for inputting alphanumerical data to a computer, wherein the inputting of alphanumerical data includes an enactment of one or more keys.

2. The device of claim 1 wherein the enactment of one or more keys comprises:
(a) a single enactment of a single key; and
(b) a simultaneous enactment of a combination of keys.

3. The device of claim 2 wherein the inputting of alphanumerical data by way of a simultaneous enactment of a combination of keys comprises the enactment of substantially vertically adjacent keys, substantially horizontally adjacent keys, diagonally adjacent keys and non-adjacent keys.

4. The device of claim 1 wherein said alphanumerical data comprises
(a) one or more characters;
(b) a phrase; and
(c) a command function.

5. The device of claim 1 wherein the alphanumerical data entry portion of the device is arranged to operate for input of alphanumerical data in a plurality of modes, and wherein the enactment of keys in a specific mode operates to input a set of alphanumerical data specific to said mode.

6. The device of claim 5 further comprising means for indicating whether the alphanumerical data entry portion is operating in a specific mode.

7. The device of claim 6 wherein said indicating means comprises a light emitting diode (LED).

8. The device of claim 1 further comprising software to audibly disclose each accepted input of alphanumerical data.

9. The device of claim 1 wherein the graphical location data entry portion and the alphanumerical data entry portion can each be separately activated or deactivated by a command function.

10. The device of claim 1 wherein the alphanumerical data entry portion includes at least two columns and at least two rows of keys.

11. The device of claim 10 wherein the alphanumerical data entry portion includes at least three columns and at least four rows of keys.

12. The device of claim 1 wherein the alphanumerical data entry portion includes at least one user programmable key.

13. The device of claim 1 wherein the graphical data entry portion includes at least 2 click buttons.

14. The device of claim 1 further comprising a scroll wheel.

15. The device of claim 1 further comprising a single input port.

16. The device of claim 1 further comprising a cordless input port.

17. The device of claim 1 further comprising a rechargeable battery source.

18. The device of claim 1 further comprising a solar cell power source.

19. A method of receiving information in a computer from a device according to claim 1, said method comprising steps of:
(a) receiving information from said device representing an enactment of at least one key on said device;
(b) converting said information into alphanumerical data; and
(c) transmitting said alphanumerical data to a computer application executing in said computer.

20. A computer readable media storing software code executable on a computer connected to a device according to claim 1, wherein said software code is operable to perform the method according to claim 19.
